(19) United States
(12) Patent Application Publication
(10) Pub. No.: US 2008/0272170 A1
(43) Pub. Date: Nov. 6, 2008

(54) AC electric nail-gun and control method of the same

(76) Inventor: Ying-Lieh Huang, Puzi City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/797,238

(22) Filed: May 2, 2007

(51) Int. Cl. B25C 5/15

(52) U.S. Cl. 227/131; 227/107

(57) ABSTRACT

The present invention relates to an AC electric nail-gun and method thereof. The AC electric nail-gun of the present invention is mainly provided with an integrated circuit (IC), and the IC is connected with a SCR (silicon controlled rectifier) drive circuit such that an actuating magnetic coil is activated by the driving of the SCR drive circuit through a SCR commanded by the IC. By means of the activating, the striker pin of the impact plunger within the actuating magnetic coil beats nail into wood. If an appropriate calculation conducted by the IC according to the reaction force obtained by the striker pin shows that the nail is not firmly beaten into wood, the impact plunger is commanded to allow the striker pin beat nail again before the plunger is brought back to its original position to be activated. A jostle device is provided correspondingly to the impact plunger in such a manner that the return stroke of the impact plunger is limited within a finite distance by mean of the push-forward action of the jostle device when actuated in the repeated nail-impacting cycle of the impact plunger. In this way, the nail can be beaten into wood with multiple stages so as to be nailed firmly into wood by the nail-gun of the present invention which makes the construction easier and more convenient to ensure the quality of construction. Therefore, the commercial availability is further enhanced in the entire operation thereof.

### BACKGROUND OF THE INVENTION

1. Field of the Invention

The present invention relates to an AC electric nail-gun and the control method thereof, more particularly to an AC electric nail-gun with novel design which can beat nails firmly into wood with multiple stages beating according to different hardness and thickness of wood to be nailed, and which can prevent the complete retraction of the striker pin so as not to cause the happening of the so called repeated nail out, which means the next nail moves upward and is beaten by the striker pin during the beating process of nail into wood with multiple stages beating of the nail-gun. In this manner, the AC electric nail-gun of the present invention makes the construction easier and more convenient to ensure the quality of construction. Therefore, the commercial availability is further enhanced in the entire operation thereof.

2. Brief Description of the Prior Art

Due to the fast progress in technology and science in contemporary world, a variety of apparatuses for offering greater convenience to the livelihood of people are emerging in an endless stream. As far as various electric apparatuses are concerned, they take use of handy electricity source available in the ambient environment as the driving power so that people can work in a free and easy style to achieve desired purpose, such as drilling by an electric drilling machine, screw fastening and releasing by an electric screwdriver, car waxing by an electric waxing machine, juicing and food processing by an electric fruit and vegetable juicer etc. These electric apparatuses have brought about significant convenience to people, and thus have become indispensable items in daily life.

As far as the electric nail-gun is concerned, it usually comprises a control element provided in a body, an actuating magnetic coil controlled by the control element, an impact plunger having a striker pin fixed within the actuating magnetic coil, and an elastic body put around the impact plunger. When the actuating magnetic coil is energized, a magnetic force is generated to act on the impact plunger to displace. The striker pin on the impact plunger beats nail into wood. After the nail is beaten into wood, the impact plunger is brought back to its original position of triggering by spring back force of the elastic body so as to wait for next nailing cycle in which a new nail is beaten into wood.

Although the above electric nail-gun can achieve the expected effect of beating nail into wood, however it is discovered in the practical usage that the striker pin of the impact plunger is immediately brought back to position of triggering by the spring back force exerted by the elastic body, simultaneously the next nail will move to the position to be beaten. Due to the fact that the woodiness and the thickness of every kind of wood are not necessarily identical, it often happens that nail cannot be beaten to the bottom of wood at one impact. As the conventional electric nail-gun cannot conduct multiple stages beating on nails, user can not but to draw out the nail and beating a new nail again, or instead to beat the nail by the other means such as hammer to the bottom. Therefore, the user often suffers significant inconvenience during the use of conventional electric nail-gun.

### SUMMARY OF THE INVENTION

The AC electric nail-gun and its control method of the present invention is mainly provided with an integrated circuit (IC), and the IC is connected with a SCR (silicon controlled rectifier) drive circuit such that an actuating magnetic coil is activated by the driving of the SCR drive circuit through a SCR commanded by the IC. By means of the activating, a striker pin of the impact plunger within the actuating magnetic coil beats nail into wood. If an appropriate calculation performed by the IC according to the reaction force from the striker pin shows that the nail is not firmly beaten into wood, the impact plunger is commanded to allow the striker pin to beat the nail again before the plunger is brought back to its original position of triggering. A jostle device is provided correspondingly to the impact plunger in such a manner that the return stroke of the impact plunger is restricted within a finite distance by mean of the push-forward action of the jostle device when activated in the repeated nail-impacting cycle of the impact plunger. After the nail is firmly beaten into wood, the jostle device stops the activating and the impact plunger with the strike pin thereon returns back to the position to be triggered. The next nail then moves upwards and is abutted by the strike pin. In this way, the nail can be beaten into wood with multiple stages so as to be nailed firmly into wood by the nail-gun of the present invention which makes the construction easier and more convenient to ensure the quality of construction. Therefore, the commercial availability is further enhanced in the entire operation thereof.

### BRIEF DESCRIPTION OF THE DRAWINGS

The present invention will be better understood by the detailed description of a preferred embodiment with reference to the accompanying drawings, in which:

FIG. 1 is a schematic view showing the configuration of the AC electric nail-gun of the present invention.

FIG. 2 is a schematic enlarged view showing the configuration of the AC electric nail-gun of the present invention.

FIG. 3 is a schematic view showing the circuit of the control device of the present invention.

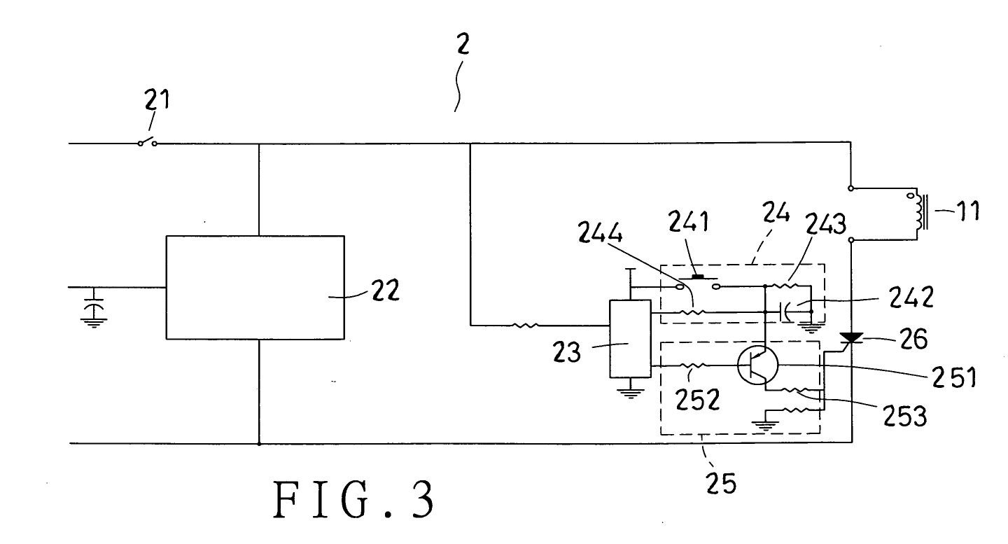

FIG. 4 is a schematic view showing a part of the circuit of the control device of the present invention.

FIG. 5 is a perspective exploded view showing the jostle device of the present invention.

FIG. 6 is a schematic view (1) showing the action of the AC electric nail-gun of the present invention.

FIG. 7 is a schematic view (2) showing the action of the AC electric nail-gun of the present invention.

FIG. 8 is a schematic view (3) showing the action of the AC electric nail-gun of the present invention.

FIG. 9 is a schematic view showing the using state of the jostle device of the present invention.

### DETAILED DESCRIPTION OF THE PREFERRED EMBODIMENTS

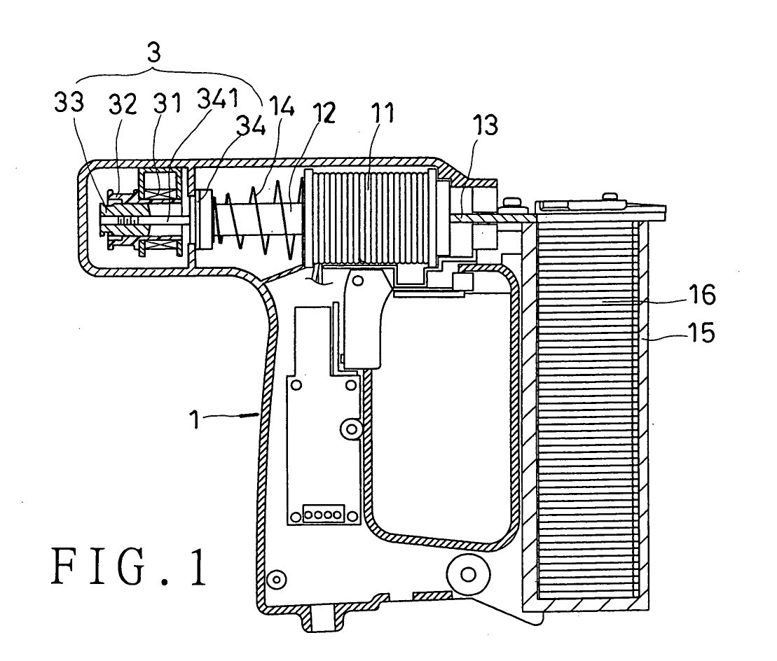

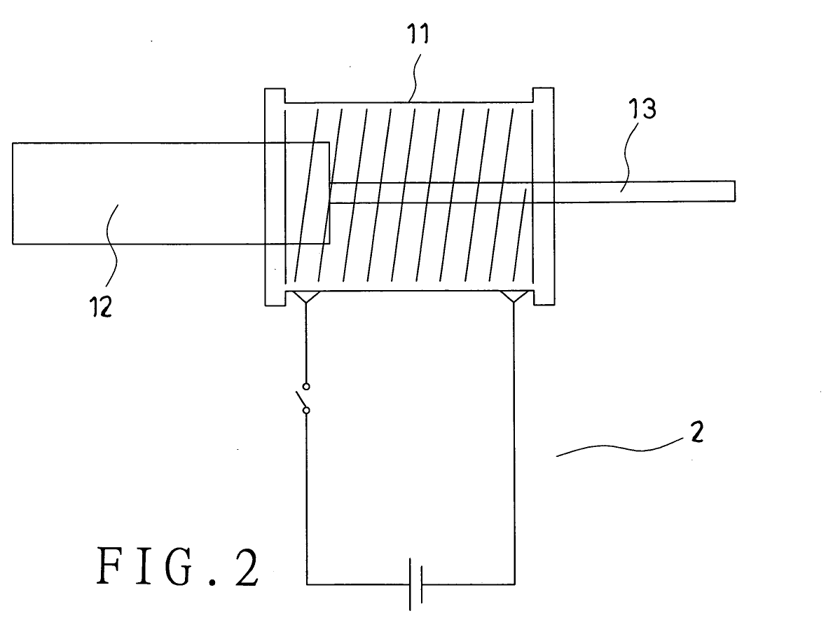

Firstly referring to FIG. 1, which shows a schematic perspective view of the AC electric nail-gun (1) of the present invention, comprising : an actuating magnetic coil (11) which is provided with an impact plunger (12) internally; a striker pin (13) fixed at the front end of the impact plunger (12), and an elastic body (14) put around the impact plunger (12); a nail cartridge (15) provided at the front end of the electric nail-gun (1) in which a plurality of nails to be successively beaten by the striker pin are contained ; a control device (2) used to control and activate the magnetic coil (11), as shown in a partial enlarged schematic view of the AC electric nail-gun (1) of the present invention of FIG. 2 ; and a jostle device (3) provided at the rear end of the impact plunger (12).

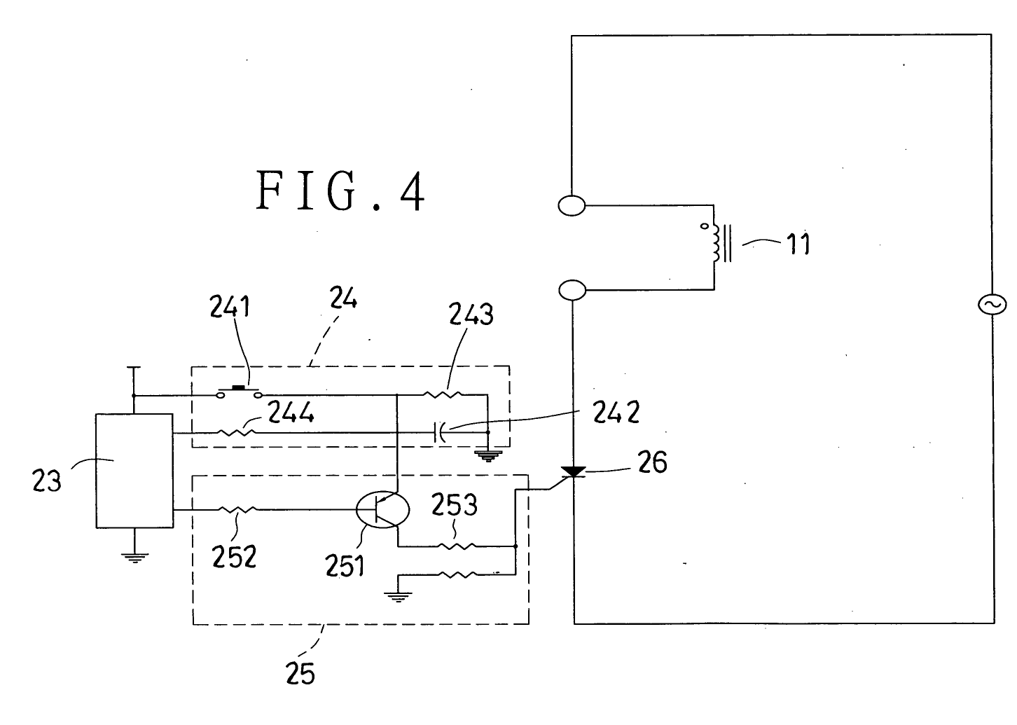

In the AC electric nail-gun (1) of the present invention, the control device (2) is provided with a power switch (21) and connected with a power circuit (22) which supplies the power required for the operation of another circuits. The control device (2) is connected with an IC (23) which in turns is connected with a start-up circuit (24) and a silicon controlled rectifier drive circuit (25) respectively, as shown in a partial schematic circuit diagram of the control device of the present invention of FIG. 4. The start-up circuit (24) has a starting switch (241) which is connected with a capacitor (242) and a discharge resistor (243). The capacitor (242) is connected to the IC (23) through a protection resistor (244). The silicon controlled rectifier drive circuit (25) has a transistor (251), the base (B) of which is connected to the IC (23) through a protection resistor (252), the emitter (E) to the capacitor (242) of the start-up circuit (24), and the collector (C) to the gate (G) of a silicon controlled rectifier (26). The anode (A) and the cathode (K) of the silicon controlled rectifier (26) are connected to the actuating magnetic coil (11) and the ground respectively.

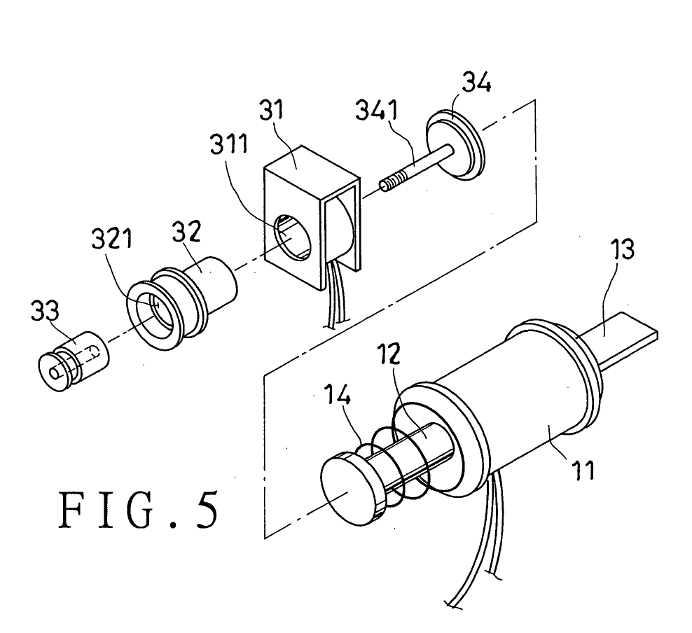

As shown in an exploded perspective view of the jostle device of the present invention of FIG. 5, the jostle device (3) is essentially provided with a magnetic flux coil (3 ) which is in synchronization with the actuating magnetic coil (11). The magnetic flux coil (31) has a through channel (311) at the center, and a sleeved brake member (32) is inserted into the through channel (311) of the magnetic flux coil (31). A through hole (321) is also provided at the center position of the sleeved brake member (32), and a metal push-block (33) is inserted into the through hole (321) of the sleeved brake member (32) at the rear end. On the other hand, a jostle member (34) is provided at the front end of the magnetic flux coil (31), and a jostle rod (341) extends inwardly from the jostle member (34) toward the interior of the through channel (311) of the magnetic flux coil (31). The jostle rod (341) extends toward the inside of the through hole (321) of the sleeved brake member (32) and engages with the metal push-block (33).

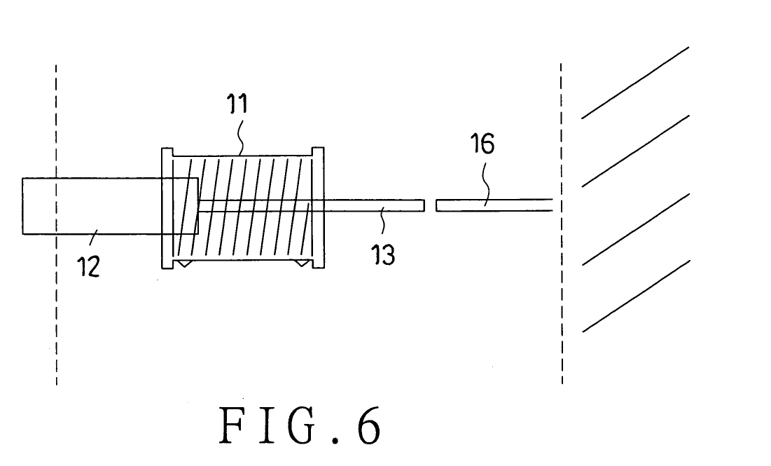

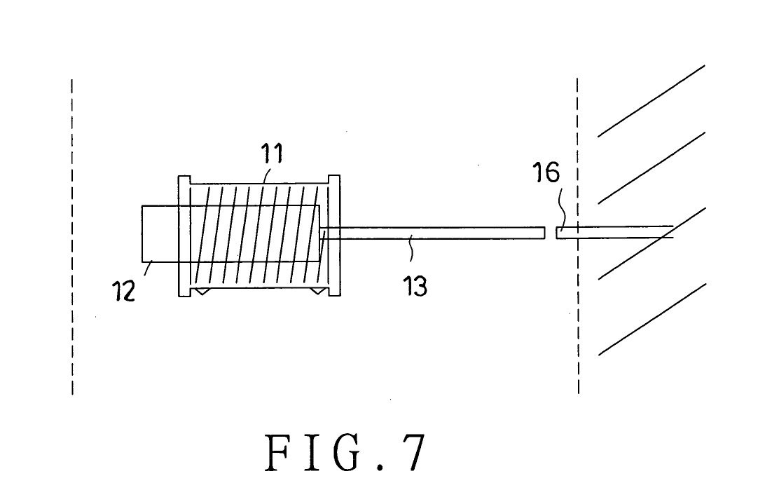

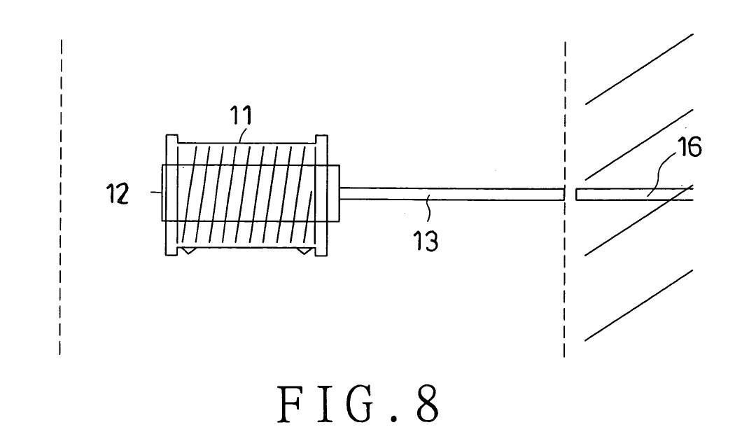

In this way, referring to the FIG. 6 to FIG. 8 which shows a schematic view (1)˜(3) of the action of the AC electric nail-gun of the present invention, when the power switch (21) of the control device (2) is inactivated, AC power signal is input into the phase-signal input terminal of the IC (23) to judge whether it is a positive peak wave or a negative peak wave. When the starting switch (241) of the start-up circuit (24) is pressed, the capacitor (242) is charged at once to an electric potential ready for driving. At this moment, the existence of the signal of electric potential is transmitted though the protection resistor (244) to the IC (23). The existence of the potential on the capacitor (242) is confirmed by the IC (23), and a triggering signal from the IC (23) after calculation will drive the transistor (251) through the protection resistor (252) of the silicon controlled rectifier drive circuit (25) such that the transistor (251) Vec set becomes ON. At this moment, the electric potential energy stored in the capacitor (242) triggers indirectly the silicon controlled rectifier (26) to become ON, such that the silicon controlled rectifier (26) activates the actuating magnetic coil (11). In turn, the striker pin (13) of the impact plunger (12) within the actuating magnetic coil (11) beats the nail (16), and the reaction force back from the striker pin (13) is transmitted into the IC (23). If a judgment made according to an appropriate calculation performed by the IC (23) based on the input reaction force that the striker pin (13) fails to firmly beat the nail (16) into wood, the actuating magnetic coil (11) is activated again by the driving of the silicon controlled rectifier (26), then the impact plunger (12) is in turn activated to impact the striker pin (13) so as to beat the nail (16) again before the impact plunger (12) is biased by the elastic body (14) back to the position to be inactivated. In order to avoid the insufficiency in the impact force of beating the nail caused by the inadequacy of beating stroke during the second beating of the nail (16), AC positive and negative peak triggering in alternation is utilized. In other words, the triggering at the second or the third positive peak instead of the first positive peak is conducted, such that the impact plunger (12) has enough time to bring the striker pin (13) back. In this way, sufficient beating stroke and force is ensured for the next beating. Thus, the repeated beatings are performed until the nail (16) is firmly beaten into wood.

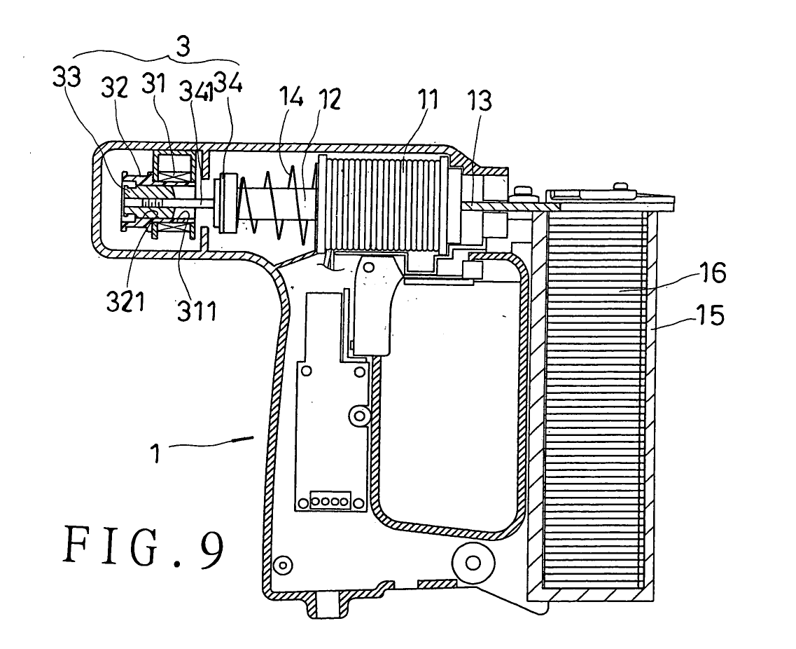

Simultaneously, referring to the schematic view showing the using state of the jostle device of the present invention of FIG. 9, the magnetic coil (31) of the jostle device (3) is activated to generate magnetic force in synchronization with the activation of the actuating magnetic coil (11) of the AC electric nail-gun (1) such that the metal push-block (33) is moved forward by the action of the magnetic force of the magnetic coil (31). Accompanying with the action, the jostle member (34) combined with the metal push-block (33) through the top jostle rod (341) thereon is also moved forward so that the return stroke of the impact plunger (12) is restricted within a finite distance. In this way, the return of the impact plunger (12) to the position to be activated can be avoided. Thus, the repeated beatings are performed until the nail (16) is firmly beaten into wood.

Summing up above, comparing with the configuration of the conventional nail-gun, the AC electric nail-gun of the present invention can firmly beat the nail into wood with multiple stages of beating according the calculation performed by the IC based on the different state of nail beaten into wood. In this manner, the AC electric nail-gun of the present invention makes the construction easier and more convenient to ensure the quality of construction. Therefore, the commercial availability is further enhanced in the entire operation thereof. While the present invention has been described with preferred embodiments in conjunction with the accompanying drawings, the preferred embodiments and the drawings are purely illustrative, and are not intended to be restrictive of the scope of the present invention. Any modifications and variations or the equivalents brought out without departing from the spirit of the present invention is considered to be still within the scope of the present invention.

What is claimed is:

1. An AC electric nail-gun, comprising
an actuating magnetic coil which is provided with an impact plunger internally,
a striker pin fixed at the front end of said impact plunger, and an elastic body put around said impact plunger,
a nail cartridge provided at the front end of said electric nail-gun in which a plurality of nails to be successively beaten by said striker pin are contained, and
a control device used to control and activate said magnetic coil,
wherein said control device is provided with an IC which in turns is connected with a start-up circuit (24) and a silicon controlled rectifier drive circuit respectively, said start-up circuit having a starting switch which is connected with a capacitor and a discharge resisto; said silicon controlled rectifier drive circuit has a transistor, the base (B) of which is connected to said IC, the emitter (E) to a capacitor of said start-up circuit, and the collector (C) to the gate (G) of a silicon controlled rectifier, the anode (A) and the cathode (K) of said silicon controlled rectifier being connected to said actuating magnetic coil and the ground respectively.

2. An AC electric nail-gun according to claim 1, wherein a jostle device is provided at the rear end of said impact plunger which is in synchronization with said actuating magnetic coil,
in this manner, the return stroke of said impact plunger is restricted within a finite distance by mean of the push-forward action of said jostle device so as not to cause the happening of repeated nail out.

3. An AC electric nail-gun according to claim 1, wherein said jostle device is essentially provided with a magnetic flux coil which is in synchronization with said actuating magnetic coil; a metal push-block being inserted into the sleeved brake member at the rear end of said magnetic flux coil, a jostle member being provided at the front end of said magnetic flux coil (31), and a jostle rod (341) extending inwardly from said jostle member toward the interior of said magnetic flux coil and engaging with said metal push-block.

4. An AC electric nail-gun according to claim 3, wherein said jostle device has a through channel at the center of said magnetic flux coil thereof, and a sleeved brake member is inserted into the through channel of said magnetic flux coil.

5. A control method of AC electric nail-gun is shown as followings
AC power signal is input into the phase-signal input terminal of said IC to judge whether it is a positive peak wave or a negative peak wave when the power switch of the control device is inactivated;
when said starting switch of said start-up circuit is pressed, said capacitor is charged at once to an electric potential ready for driving, the electric potential being transmitted to said IC and a triggering signal came from said IC after calculation drives said transistor such that the electric potential energy stored in the capacitor triggers said silicon controlled rectifier to become ON, which in turn activates the actuating magnetic coil and said striker pin of said impact plunger within said actuating magnetic coil beats the nail
the reaction force from said striker pin is transmitted into said IC, if a judgment made according to an appropriate calculation performed by said IC based on said reaction force that said striker pin fails to firmly beat the nail into wood, said actuating magnetic coil is activated again by the driving of said silicon controlled rectifier to impact said striker pin so as to beat the nail again before said impact plunger is biased by said elastic body back to the position to be activated,
in this manner, the repeated beatings are performed until the nail is firmly beaten into wood.

6. A control method of AC electric nail-gun according to claim 5, wherein AC positive and negative peak triggering in alternation is utilized in order to avoid the insufficiency in the impact force of beating the nail caused by the inadequacy of beating stroke during the second beating of the nail, in other words, the triggering at the second or the third positive peak instead of the first positive peak is conducted such that said impact plunger has enough time to bring said striker pin back,
in this manner, sufficient beating stroke and force is ensured for the next beating.
